(19) United States
(12) Patent Application Publication
(10) Pub. No.: US 2009/0144082 A1
(43) Pub. Date: Jun. 4, 2009

(54) Physician practice management software for maximizing reimbursement rates from payer contracts

(76) Inventors: Steven Selbst, Salinas, CA (US); Susan Charkin, Salinas, CA (US)

Correspondence Address: Ober, Kaler, Grimes & Shriver, 120 East Baltimore Street, Baltimore, MD, 21202-1643, US

(21) Appl. No.: 12/313,492

(22) Filed: Nov. 20, 2008

Related U.S. Application Data
(60) Provisional application No. 61/004,819, filed on Nov. 30, 2007.

(51) Int. Cl. G06Q 50/00; G06Q 40/00

(52) U.S. Cl. 705/2

(57) ABSTRACT

A software solution for optimizing healthcare providers' profitability by benchmarking payer reimbursements to the Medicare locality rates and rates of other payers, by analyzing a payer contract's operational language, by modeling the effect on revenue of a provider's decision to stay in a payer's network, by modeling the effect on revenue of a provider's decision to adjust charge master rates, and by sampling a provider's claims.

### CROSS-REFERENCE TO RELATED APPLICATIONS

The present application derives priority from U.S. Provisional Patent Application 61/004,819 filed on Nov. 30, 2007, which is incorporated herein by reference.

### BACKGROUND OF THE INVENTION

1. Field of the Invention

The present invention relates to healthcare provider management software. More particularly, the present invention relates to software that enables physician practices and Ambulatory Surgery Centers to maximize revenue by providing important financial analysis and modeling.

2. Description of the Background

Healthcare providers generally negotiate their fees and services with insurance companies (known as “payers”), with the exception of Medicare and Medicaid agreements that are government sponsored. These payers are often large national companies with significant bargaining leverage and well-developed tools (such as software) that analyze the quality and cost efficiency of their patients' healthcare providers.

For example, United States Patent Application 20040111291 by Dust et al. (Key Benefit Administrators) published Jun. 10, 2004, shows a method of optimizing healthcare services through analysis of the demographic and wellness characteristics of an employee population, analysis of the quality and cost efficiency of the providers used by the patients, and intervention with patients to urge them to the most cost efficient providers.

United States Patent Application 20070088580 by Richards published Apr. 19, 2007, shows a method and system for providing comparative health care information to consumers using a network to assist in their provider decisions.

United States Patent Application 20070061393 by Moore published Mar. 15, 2007, shows a system for syndication and management of healthcare data to assist institutional healthcare delivery.

United States Patent Application 20070043595 by Pederson published Feb. 22, 2007, shows a system for estimating costs under health care plans.

U.S. Pat. No. 7,065,528 to Herz et al. issued Jun. 20, 2006, shows a professional referral network with a geographical matching system.

United States Patent Application 20060129428 by Wennberg (Health Dialog Services Corporation) published Jun. 15, 2006, shows a system and method for predicting healthcare related financial risk using patient, geographic, and healthcare system data, and for applying a predictive risk model to the data to generate patient profile data and to identify a portion of the patients associated with a level of predicted financial risk.

United States Patent Application 20060080139 by Mainzer (Woodhaven Health Services) published Apr. 13, 2006, shows a Resource Utilization Group assessment tool that projects reimbursement under the Medicare Prospective Payment System. A user may enter a complete drug regimen and estimate the costs for the regimen. Similarly, managed care reimbursements from managed care organizations are analyzed. Also, drug costs may be estimated through a Medicaid Preferred Drug List database that identifies potential non-preferred drugs that may be non-compensable.

Armed with the foregoing tools and greater bargaining power, payers rarely pay providers' standard charge master rates, but rather negotiate lower rates with providers. Some large providers such as hospital systems may have bargaining power, but most primary care physicians operate alone or in small practice groups. These providers are well accustomed to accepting reimbursement rates on a take-it-or-leave-it basis.

Many providers are finding, however, that negotiating with payers for more equitable payments is possible. This result, however, requires solid data and a well-reasoned approach. The most common approach is to calculate desired reimbursement rates as a percentage of Medicare's reimbursement rates. For example, a provider may argue for reimbursement of a certain procedure at 110 percent of the Medicare locality rate for a specific Current Procedural Terminology code (“CPT code”)—a code published by the American Medical Association that uniformly describes a medical, surgical, or diagnostic service, such as an office visit, CPT code 99214. Today, Medicare locality rates for specific CPT codes are accessible to any provider by using the “Medicare Physician Fee Schedule Look-Up” tool on the Centers for Medicare and Medicaid Services website, www.cms.hhs.gov/PFSlookup/. In a given physician practice, increasing the reimbursement rate for approximately 40 CPT codes by only one dollar can translate into tens or hundreds of thousands of dollars in additional revenue if these 40 CPT codes are 80%-85% of a practice's overall volume.

Benchmarking reimbursement rates with Medicare locality rates, however, is only one tool to use in rate renegotiation. A successful rate renegotiation often entails more than a rate analysis—good negotiation skills are also helpful. See, e.g., Giovino J M, You Can't Always Get What You Want . . . . But Sometimes You Can, Family Practice Management, November/December 1999, at 24-27. Perspective is also important. When a payer contract reimbursement rate is extremely low, it may be financially wiser for a healthcare provider to simply drop the contract. Healthcare providers, however, often lack the tools and are ill-equipped to handle such analyses and negotiations. There is one known attempt to do so.

United States Patent Application 20060106653 by Lis (Siemens Corporation) published May 18, 2006, shows a healthcare reimbursement claim processing simulation and optimization system that permits a healthcare provider to perform flexible, efficient, and timely multiple analyses of managed care organization contracts, over a large database of historical information, to provide associated profitability information (including reimbursement based on different reimbursement formulae). The pending, unexamined claims are drawn to a financial claim reimbursement simulation system, comprising a comparison of different financial claims for reimbursement based on a plurality of different predetermined reimbursement formulae. The system provides calculated data for use in determining a reimbursement value based on different reimbursement formulae.

A software solution comprising a suite of tools that provides a variety of information needed to “level the playing field” with payers in contract negotiations would be more advantageous for maximizing revenue. The present invention facilitates a quick and effective analysis of a healthcare provider's practice to optimize the provider's profitability by providing comparative payer reimbursement rate information (benchmarking), suggestions on a payer contract's operational language, financial modeling of out-of-network procedures and cash-paying-patient rates, and analysis of claims made to payers.

### SUMMARY OF THE INVENTION

Accordingly, it is an object of the present invention to provide a software solution that enables healthcare providers, namely physician practices and Ambulatory Surgery Centers (“ASCs”), to analyze their payer contracts to maximize reimbursement levels by benchmarking reimbursement rates with the Medicare locality rates and the rates of other payers, thereby indicating whether a provider's current reimbursement rates are consistent with the market value.

Another object is to identify healthcare providers with similar practices in close proximity to the software user.

Another object is to provide modeling tools to evaluate whether healthcare providers' charge master rates are set at a level that maximizes revenue from cash paying patients.

Another object is to model the effect on revenue of a healthcare provider's decision to stay within a payer's network.

Another object is to determine whether a payer is under or overpaying the healthcare provider for certain procedures.

Still another object is to examine the operational language of payer contracts for potential areas of improvement.

According to the present invention, the above-described and other objects are accomplished by software that provides financial analysis and modeling to healthcare providers, enabling them to maximize revenue. This software solution provides key information needed to “level the playing field” with payers in contract negotiations. The present invention facilitates a quick and effective analysis of payer contracts to optimize a healthcare provider's revenue by providing important comparative rate information, as well as suggestions about a payer contract's operational language, and financial modeling of out-of-network procedures, cash-paying-patient rates, and actual claims made to payers.

The software solution that accomplishes the foregoing comprises different software modules, including the following:
(1) Data Entry: provides user interfaces for entering and storing data related to a user's practice—business type, locations, payers, and specialties—and to charge master and payer reimbursement data;
(2) Rate Analysis: benchmarks reimbursements for particular procedures, by payer and in aggregate, to Medicare locality rates (using the AMA's CPT codes and latest Medicare locality rates) and to rates of other payers in the region, state, or United States;
(3) Geographic Look Up: identifies how many similar practices are within a close proximity and calculates how close they are;
(4) Contract Language Analysis: evaluates a payer contract's operational language by a question-and-answer process, and provides suggestions for improvements;
(5) Bill Charges Modeler: models a practice or ASC to determine how adjustments to payer reimbursement rates and to a provider's charge master rates will affect revenue;
(6) Out-of-Network Modeler: models the effect on revenue of being within or out of a specific payer's network;
(7) Claim Analyzer: samples claims to determine if the practice is being under or over paid by a payer and by how much; and
(8) Document Repository: provides a secure and easy to find web-based storage place for all contracts, reports, fee schedules, and other documents related to a practice's payer contracts.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a top level diagram illustrating the web-based software of the present invention available through a main web portal 10, comprising the following modules: Data Entry 20, Rate Analysis 30, Geographic Look Up 40, Contract Language Analysis 50, Out-of-Network Modeler 60, Bill Charges Modeler 70, Claim Analyzer 80, and Document Repository 90;

FIG. 2 is a screen print of an exemplary Home page of the main web portal 10 as in FIG. 1;

FIG. 3 is a screen print of an exemplary Data Entry user interface for entering a provider profile dataset;

FIG. 4 is a screen print of an exemplary Business Type user interface;

FIG. 5 is a screen print of an exemplary Location user interface;

FIG. 6 is a screen print of an exemplary Payers user interface;

FIG. 7 is a screen print of an exemplary Specialties user interface;

FIG. 8 is a screen print of an exemplary Data Entry user interface for entering charge master and payer reimbursement data;

FIG. 9 is a screen print of an exemplary Charge Master Data Entry user interface;

FIG. 10 is a screen print of an exemplary Payer Reimbursement Data Entry user interface;

FIG. 11 is screen print of an exemplary Report user interface;

FIG. 12 is a screen print of an exemplary ASC Report produced by the Rate Analysis 30 module;

FIG. 13 is a screen print of an exemplary report produced by the Geographic Look Up 40 module;

FIG. 14 is a screen print of an exemplary report produced by the Contract Language Analysis 50 module;

FIG. 15 is a screen print of an exemplary Business Modeling Tools user interface;

FIG. 16 is a screen print of an exemplary report produced by the Out-of-Network Modeler 60 module;

FIG. 17 is a screen print of an exemplary report produced by the Bill Charges Modeler 70 module;

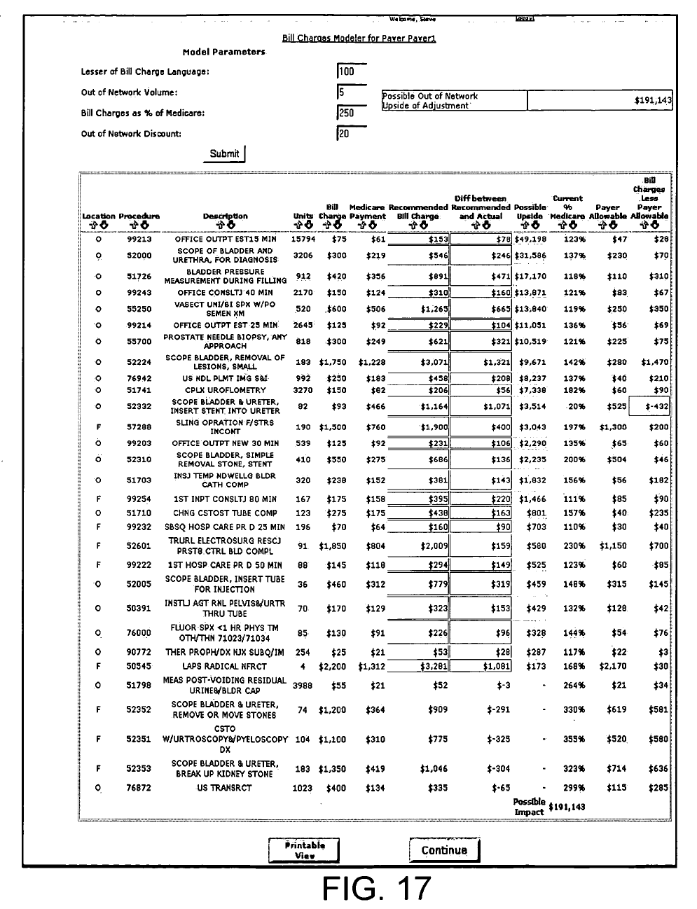

FIG. 18 is a screen print of an exemplary report produced by the Claim Analyzer 80 module; and

FIG. 19 is a screen print of an exemplary Document Repository user interface.

### DETAILED DESCRIPTION OF THE PREFERRED EMBODIMENTS

A software solution is disclosed that enables healthcare providers, including physician practices and ASCs, to optimize their profitability by benchmarking reimbursements to the Medicare locality rates and rates of other payers, by analyzing a payer contract's operational language, by modeling the effect on revenue of a provider's decision to stay in a payer's network and to change charge master rates, and by sampling a provider's claims.

The software of the present invention comprises complementary software modules that provide a “dashboard” of information for navigating physician practice management decisions, and especially to level the informational playing field with payers during contract negotiations. The software facilitates a quick and effective analysis of payer contracts to determine whether payer contracts need to be renegotiated, and provides comparative rate information necessary when renegotiating these contracts.

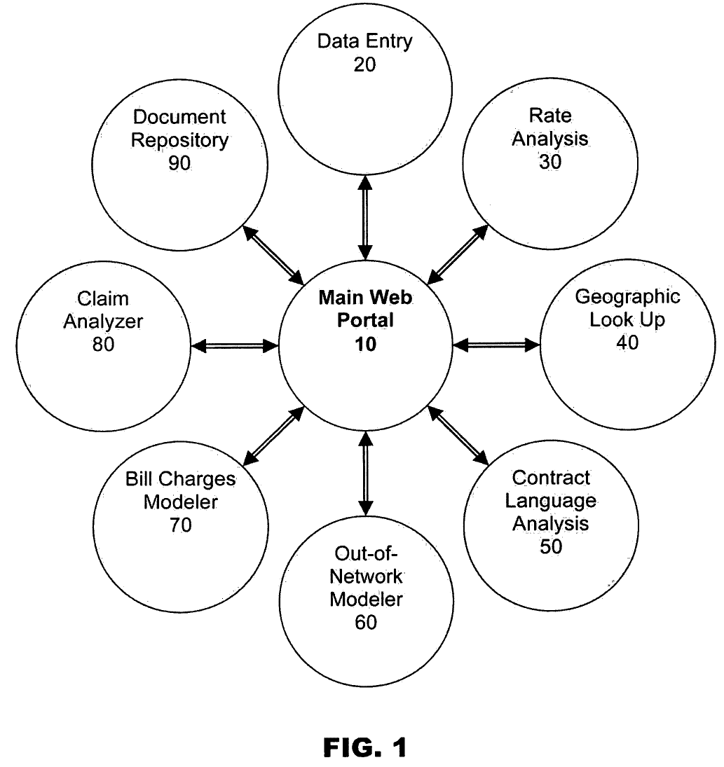

FIG. 1 is a top level diagram illustrating the software of the present invention, which is accessible through a main web portal 10. The software comprises the following modules:
(1) Data Entry 20: provides user interfaces for entering and storing data related to a user's practice—business type, locations, payers, and specialties—and for entering and storing charge master and payer reimbursement data;
(2) Rate Analysis 30: benchmarks reimbursement rates for different CPT codes, by payer and in aggregate, to Medicare locality rates (using the AMA's CPT codes and latest Medicare rates) and to rates of other payers in the region, state, or United States;
(3) Geographic Look Up 40: identifies other healthcare providers within close proximity to the user's practice and calculates how close they are;
(4) Contract Language Analysis 50: evaluates a payer contract's operational language by a question-and-answer process, and provides advice for improvements. (Specifically, the module identifies clauses related to key items such as implants, multiple procedures, term and termination, and time to pay claims, and then provides specific suggestions for possible changes.);
(5) Bill Charges Modeler 60: models a practice or Ambulatory Surgery Center (“ASC”) to determine how shifts to payer reimbursement rates and to a provider's charge master rates will affect revenue;
(6) Out-of-Network Modeler 70: models the effect on revenue of being within or out of a specific payer's network;
(7) Claim Analyzer 80: samples claims to determine if the practice is being under or over paid by a payer and by how much; and
(8) Document Repository 90: provides a secure and easy to find web-based storage place for all contracts, reports, fee schedules, and other documents related to payer contracts.

Preferably, the software of the present invention is accessible through the use of a main web portal 10 and is deployed on one or more web-enabled back-end servers hosting a resident database and user interfaces in the form of a website that can be reached by users at an appropriately named URL, for example, www.healthcentsrevolution.com. The web-enabled back-end server(s), database, and website may be maintained by a third party application service provider. Access to the main web portal 10 may be restricted through the use of a username and password received after proper registration. The user is initially directed to the main web portal's Home page. From the Home page, the user has access to the above-described modules of the present invention.

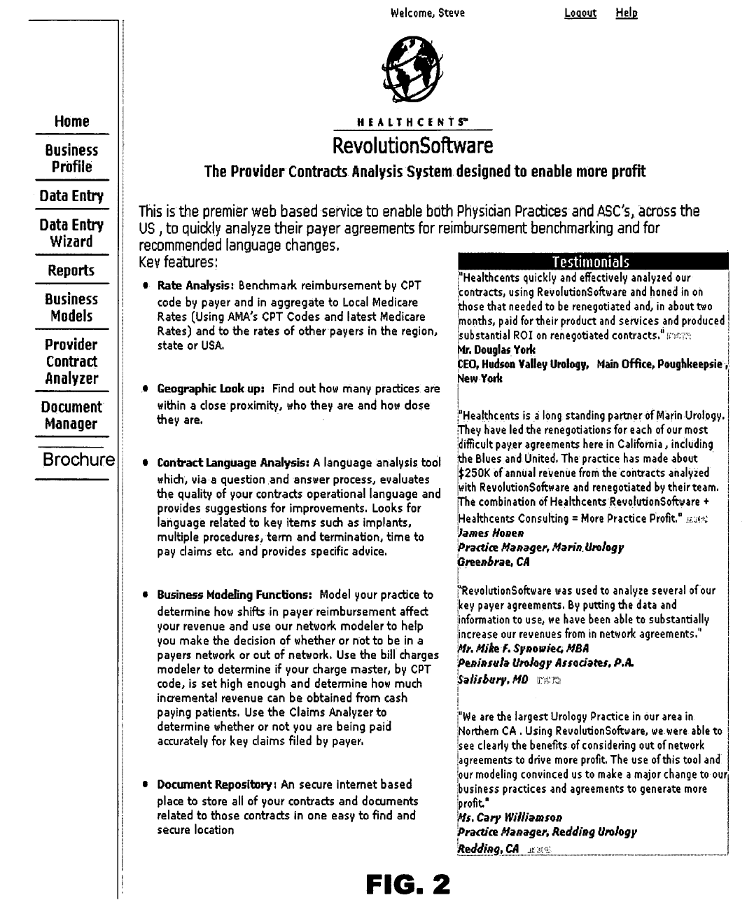

FIG. 2 is a screen print of an exemplary Home page, which includes an introductory description of the software and the different software modules. Most importantly, however, the main web portal 10 has a quick navigational menu along the left-hand side of the screen. The links of the navigational menu direct the user to the different software modules. As shown in FIG. 2, the links are labeled “Home,” “Business Profile,” “Data Entry,” “Data Entry Wizard,” “Reports,” “Business Models,” “Provider Contract Analyzer,”, “Document Manager,” and “Brochure.” The Home link returns the user to the Home page and the Brochure link provides additional information on the software.

1. Data Entry 20

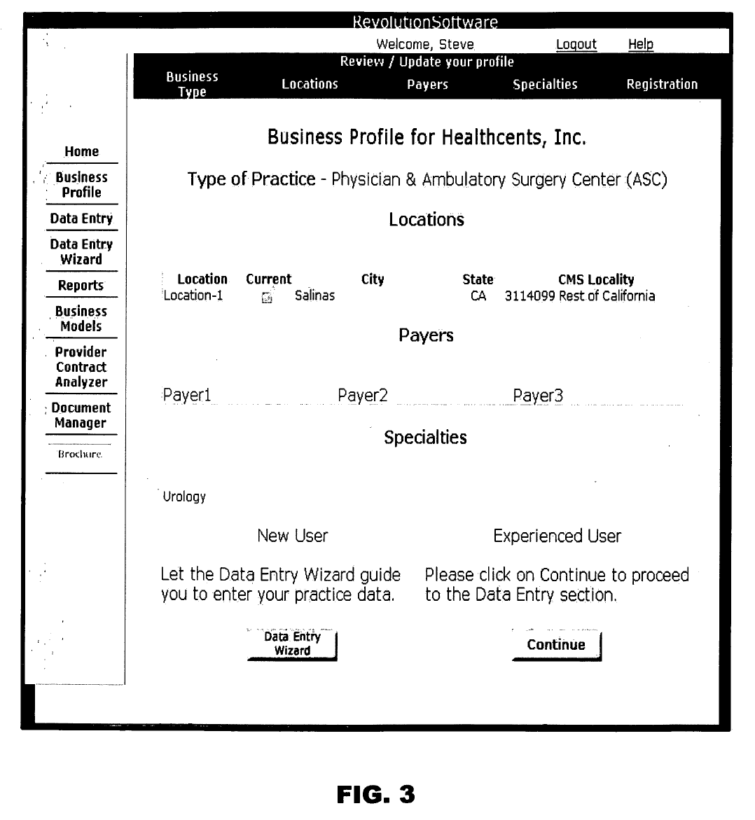

The Data Entry 20 module provides user interfaces for inputting data, including a user interface for entering and storing a provider profile dataset comprising business type, office locations, list of payers, and specialties. The entered profile dataset is used by other software modules to provide a comparative analysis by business type, locations, payers, and specialties. In FIG. 2, the Business Profile link directs the user to a user interface of the Data Entry 20 module for adding and updating the provider profile dataset for a current user. FIG. 3 is an exemplary screen print of the Data Entry 20 user interface for entering a provider profile dataset.

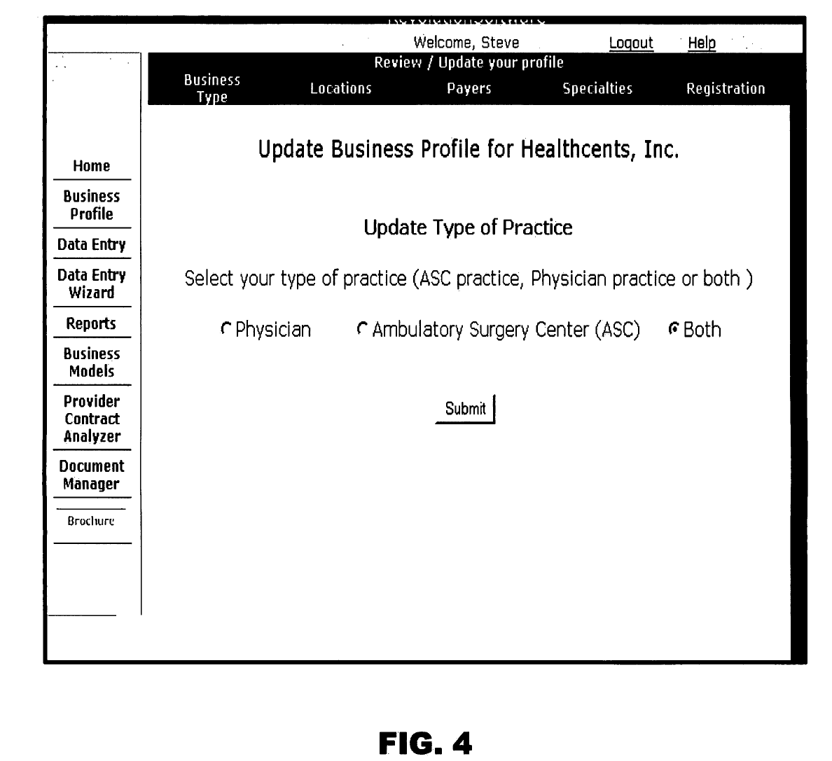

Across the top of this user interface (FIG. 3) are links that allow the user to review and update its current profile dataset by business type, locations, payers, and specialties. The Data Entry 20 module further comprises a Business Type user interface for categorically defining the healthcare provider's business type as an ASC, a physician practice, or both. FIG. 4 is a screen print of an exemplary Business Type user interface.

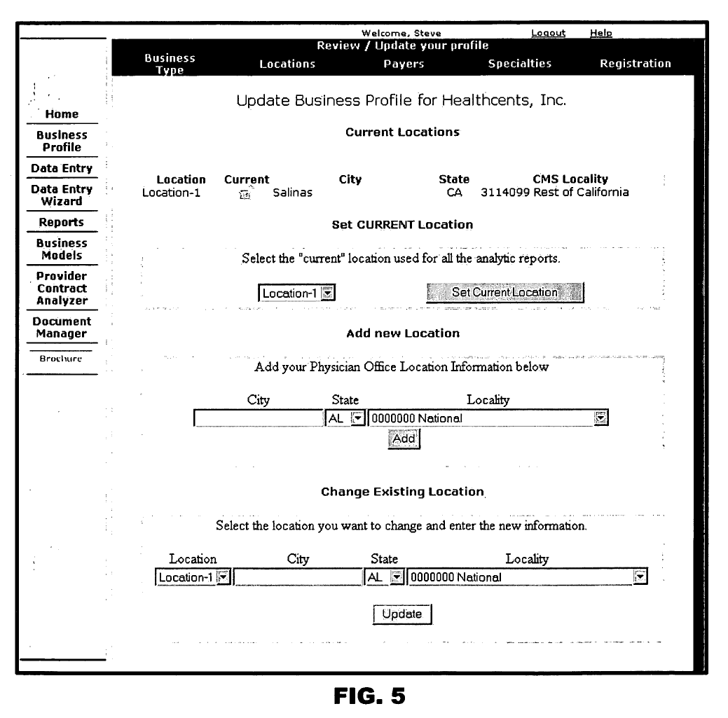

The Data Entry 20 module is also composed of a Location user interface for identifying the provider's office location(s). For the software to determine a user's Medicare locality, the office location must be defined by both city and state. Location, however, is only required for a physician practice and is not relevant to an ASC analysis. In the Location user interface, the user can add a new location, change an existing location, or set a different location as the “current” location for the analytic reports, which is necessary because each location has a separate charge master and different payer reimbursement data because each office has different clients. FIG. 5 is a screen print of an exemplary Location user interface.

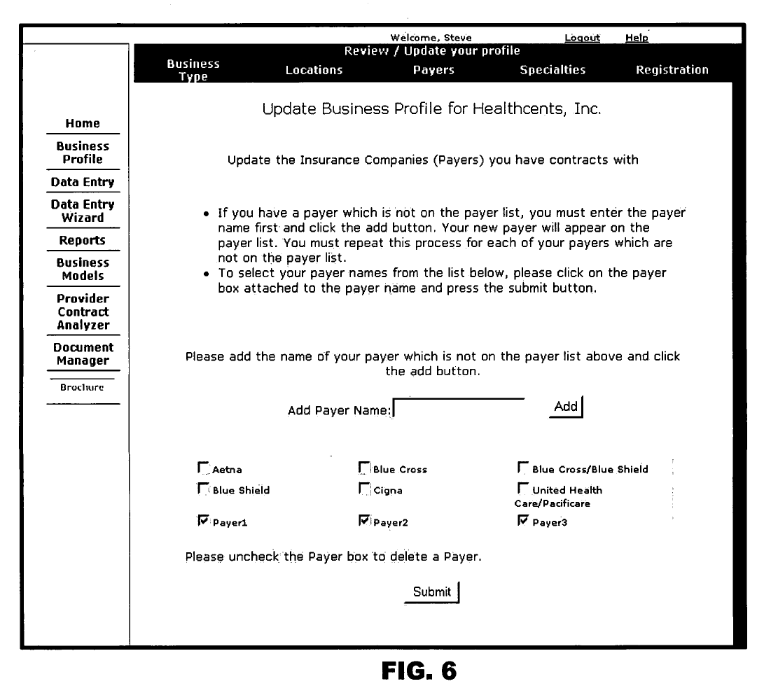

Also included in the Data Entry 20 module is a Payers user interface for providing a list of a user's payers. In the Payers user interface, the user can add a payer by either selecting a payer from a pre-existing list of potential payers or manually entering the name of a payer not on the pre-existing list, and the user can remove an existing payer. FIG. 6 is a screen print of an exemplary Payers user interface. In this embodiment, the pre-existing list includes major national payers such as Aetna, Blue Cross, Blue Cross/Blue Shield, Cigna, and United Health Care/PacifiCare.

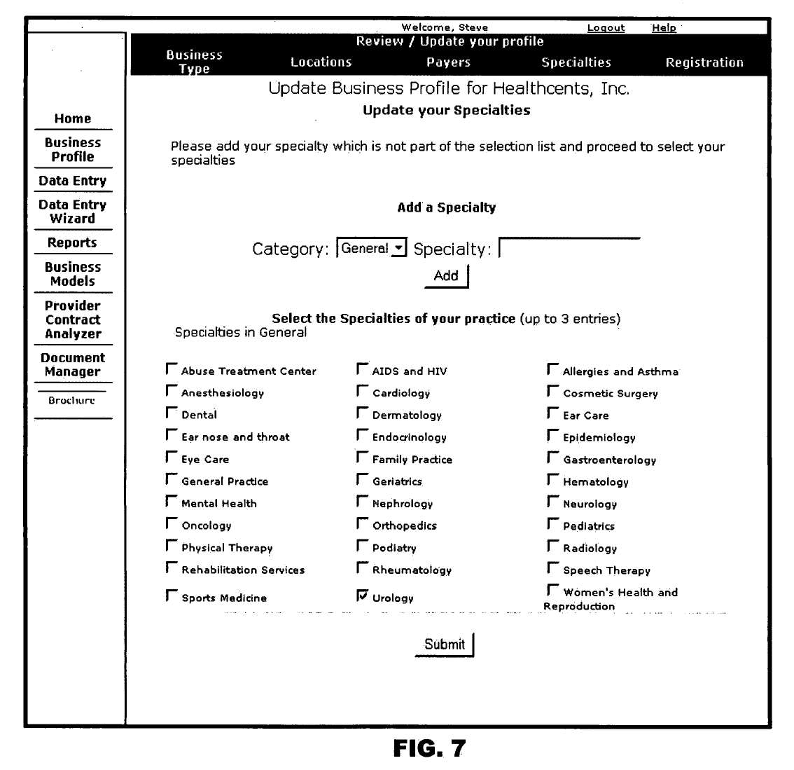

Another element of the Data Entry 20 module is a Specialties user interface that allows a user to identify a specialty practice area. This information is used with the Geographic Look Up 40 module to illustrate a user's leverage with payers—if the user is the only practice offering a certain service in an area, the user will potentially have more leverage in negotiating a contract. The user can select a specialty from a pre-existing list, manually enter a specialty not on the pre-existing list, or remove a specialty. FIG. 7 is a screen print of an exemplary Specialties user interface.

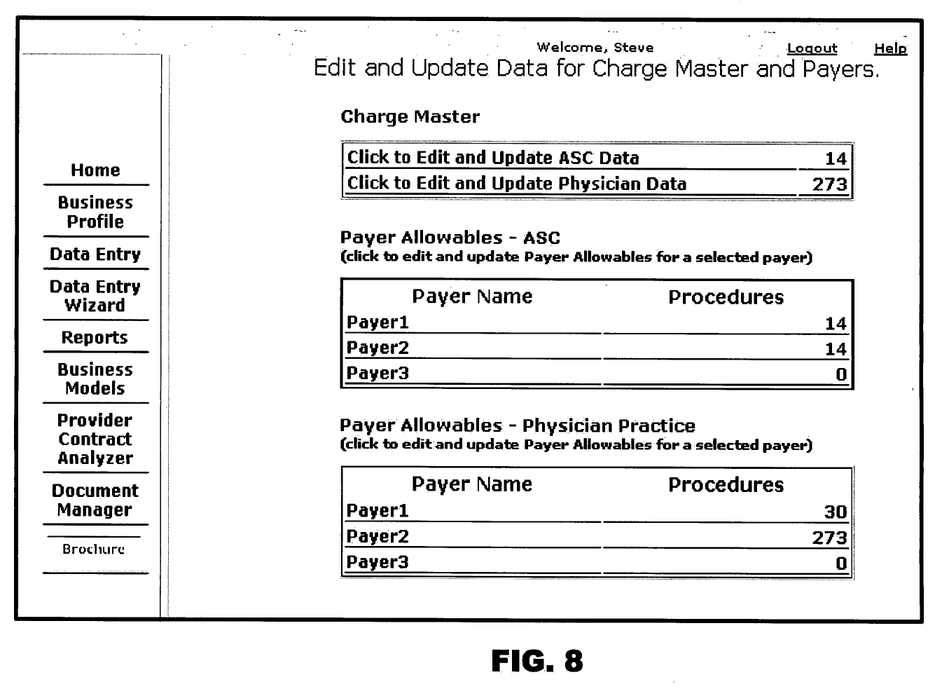

The Data Entry 20 module also allows the user to enter financial data necessary for the analysis and modeling. The module provides user interfaces for entering and storing a user's charge master and payer reimbursement data. Charge master data includes information about specific procedures performed annually (volume and type), the amount charged to cash paying patients for each type of procedure, and at which location the procedure is performed. The payer reimbursement data, also known as maximum payer allowables, are the dollar amounts a user's payer is reimbursing it for each type of procedure performed. Methods a user can input charge master data and payer reimbursement data include, but are not limited to, uploading a Microsoft Excel spreadsheet in CSV format, bulk entering the data by a Bulk Data Entry user interface; and manually entering the data a single entry at a time. FIG. 8 is a screen print of an exemplary Data Entry user interface for entering charge master and payer reimbursement data. This page includes separate links to edit or update charge master data and payer allowables. Clicking any of these links allows entry, editing, or deletion of the corresponding data.

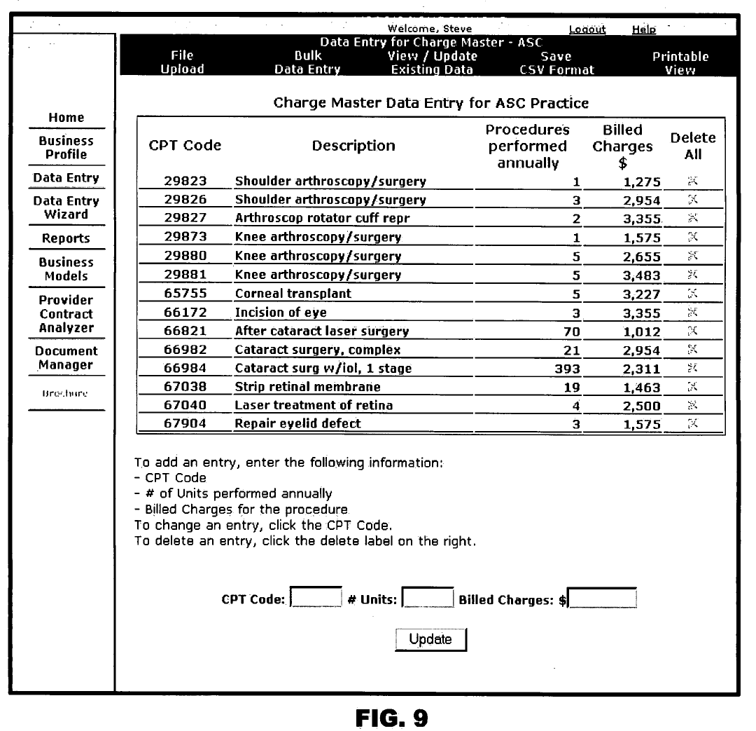

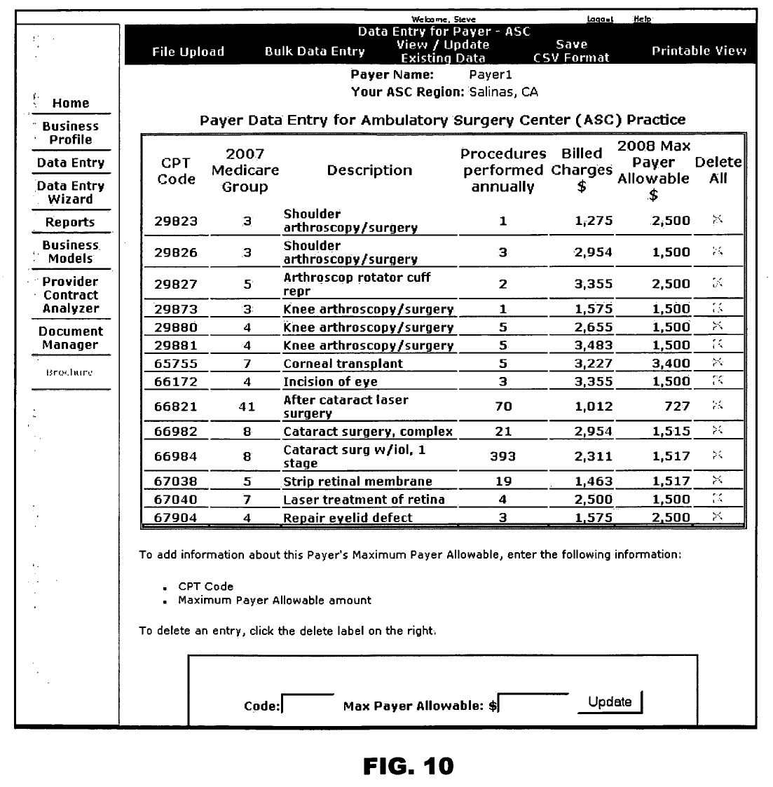

FIG. 9 is a screen print of an exemplary Charge Master Data Entry user interface, and FIG. 10 is a screen print of an exemplary Payer Reimbursement Data user interface. Across the top of both user interfaces (FIGS. 9 and 10) run a series of links that provide the following editing options labeled “file upload” (for uploading a CSV data file), “bulk data entry” (for spreadsheet-like data entry), “view/update existing data” (brings the user back to the user interface of FIG. 9 or FIG. 10 for line-item entry or editing), “save CSV format” (saves the entered charge master data or payer reimbursement data as a CSV file), and “printable view” (provides a view of the charge master data or payer reimbursement data that is printer-friendly). Displayed in the Charge Master Data Entry user interface (FIG. 9) is entered data including a specific procedure's CPT code, description (automatically generated by the software from the entered CPT code), number of times performed annually, and cost for cash paying patients. In the exemplary embodiment, the Charge Master Data Entry user interface includes a delete-all function for each procedure. At the bottom of the Charge Master Data Entry user interface, a user can add an entry by entering a procedure's CPT code, number of times performed annually, and cost. Displayed in the Payer Reimbursement Data Entry user interface (FIG. 10) is entered charge master data (CPT code, number of times a procedure is performed annually, and cost for cash paying patients), each procedure's Medicare Group (the 2007 ASC fee schedule grouping for the CPT code), and a payer's maximum payer allowable (the maximum amount the payer will reimburse the provider for a given procedure). The Medicare Group is given for historic purpose and reference—after 2007, the Medicare Group is no longer used to calculate the Medicare locality rates. Additionally, the Medicare Group is only applicable to ASCs, not physician practices. At the bottom of the Payer Reimbursement Data Entry user interface, a user can add an entry by entering a procedure's CPT code and maximum payer allowable amount.

In the preferred embodiment, the Data Entry 20 module includes a Data Entry Wizard that conducts a guided interview to collect all necessary data to establish complete provider profile, charge master, and payer reimbursement datasets for the current user. A wizard is user interface that presents the user with a sequence of dialog boxes that lead the user through a series of steps in a specific sequence. The other software modules use the completed datasets to perform the analysis and modeling.

2. Rate Analysis 30

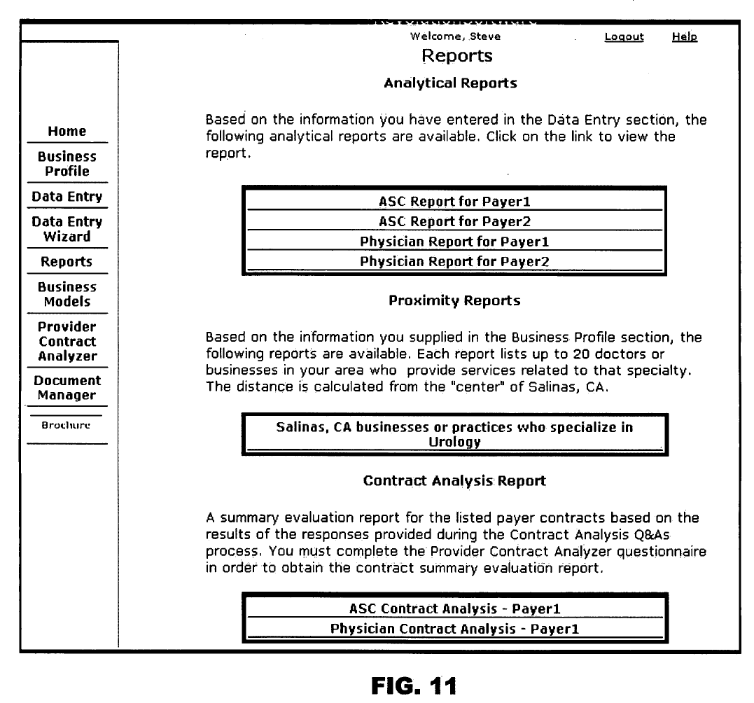

The Rate Analysis 30, Geographic Look Up 40, and Contract Language Analysis 50 modules are available through the Reports link on the navigational menu. Clicking the Reports link directs the user to a Reports user interface. FIG. 11 is a screen print of an exemplary Reports user interface. From the Report user interface, the user can click on the appropriate link to access the Rate Analysis 30, Geographic Look Up 40, and Contract Language Analysis 50 modules.

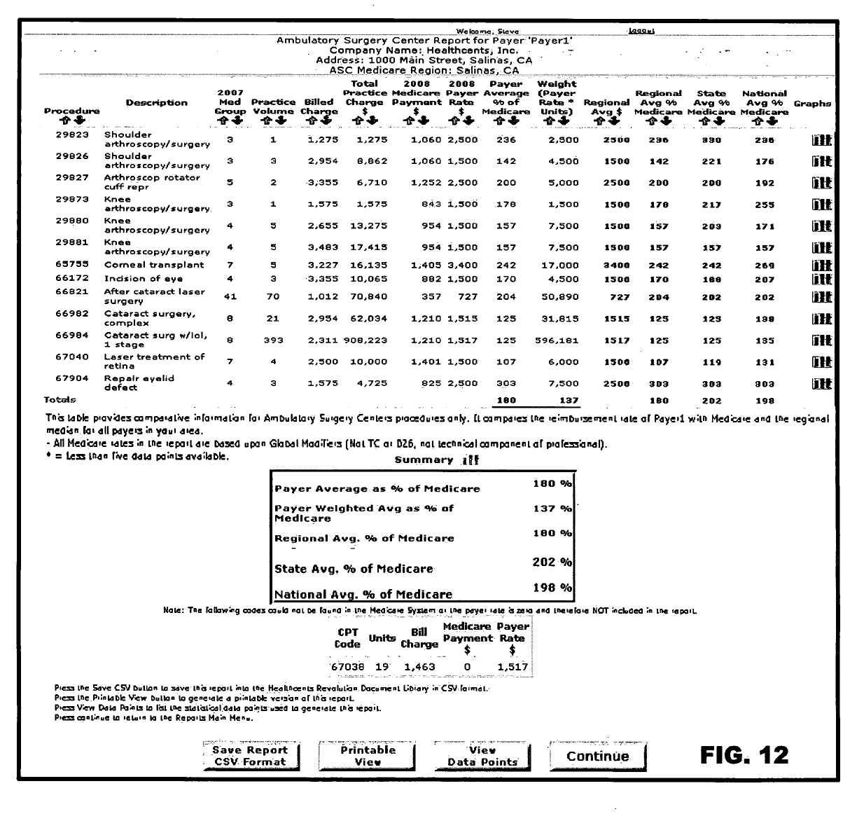

The Rate Analysis 30 module compiles either an ASC Report, a Physician Report, or both if the user is both an ASC and a physician practice, all of which are accessible from Reports user interface (FIG. 11). FIG. 12 is a screen print of an exemplary ASC Report for a certain payer produced by the Rate Analysis 30 module. The report includes the following categories of information: Procedure, Description, Med Group, Practice Volume, Bill Charge, Total Charge, Medicare Payment, Payer Rate, Payer Average Percent of Medicare, Weight, Regional Average Rate, Regional Average Percent of Medicare, State Average Percent of Medicare, and National Average Percent of Medicare. The user can sort the data of each category in ascending or descending order by clicking on the up or down arrows at the top of each column.

The Procedure, Practice Volume, Bill Charge, and Med Group values are collected or created by the Data Entry 20 module. The Procedure category is a list of each procedure's CPT code. The Description is a verbal description of the procedure. The Practice Volume value is the number of times a procedure is performed annually. The Bill Charge value is the rate for a procedure in the user's charge master. The Med Group category is the Medicare group classification for a procedure. The Total Practice Charge is a theoretical amount of how much revenue would be collected if a provider only performed out-of-network procedures for cash paying patients and is calculated by multiplying the Practice Volume by the Billed Charge. The Medicare Payment is the Medicare locality rate derived from the current Medicare Physician Fee Schedule, the AMA CPT Codes database, and global modifiers that adjust the national rate for locality cost of living adjustments. The Payer Rate is the payer allowable rate for a particular procedure, collected by the Data Entry 20 module. The Weight is a theoretical amount of revenue a provider would receive from reimbursements if all procedures were performed in network at the maximum payer allowable rate—the Payer Rate is multiplied by Practice Volume. The Payer Average Percent of Medicare is calculated by dividing the Payer Rate amount by the Medicare Payment amount and multiplying by 100. The Regional Average Rate, State Average Rate (internally calculated), National Average Rate (internally calculated) amounts are determined from data points of payer rates entered by other providers using the software in the same Medicare locality, state, and nation, respectively, and from software-defined historic values for the same Medicare locality, state, and nation, respectively. If there are less than five total data points, these values are the average of their respective data points, but if there are five or more data points, these values are the median of the data points. The Regional Average Percent of Medicare, State Average Percent of Medicare, and National Average Percent of Medicare are calculated by dividing their respective average rates by the Medicare Payment and multiplying by 100.

In addition to the values associated with each procedure, the report includes a summary of the statistics by providing the Payer Average as Percent of Medicare (the average of all Payer Average Percent of Medicare values for each procedure), Payer Weighted Average as Percent of Medicare, Regional Average Percent of Medicare (the average of all Regional Average Percent of Medicare values for each procedure), State Average Percent of Medicare (the average of all State Average Percent of Medicare values for each procedure), and National Average Percent of Medicare (the average of all National Average Percent of Medicare values for each procedure). The Payer Weighted Average as Percent of Medicare is a weighted average of all procedures combined. This value is calculated with the following formula:

$$\frac{\begin{matrix}{\sum }_{i = 1}^{n} practice {volume}_{i} \times payer {allowable}_{i} \times \\ payer average percent of {medicare}_{i}\end{matrix}}{{\sum }_{i = 1}^{n} practice {volume}_{i} \times payer {allowable}_{i}} .$$

The Report Analysis 30 module produces an identical report for a physician practice with the one exception that the report will distinguish reimbursements for Office and Facility based surgeries.

3. Geographic Look Up 40

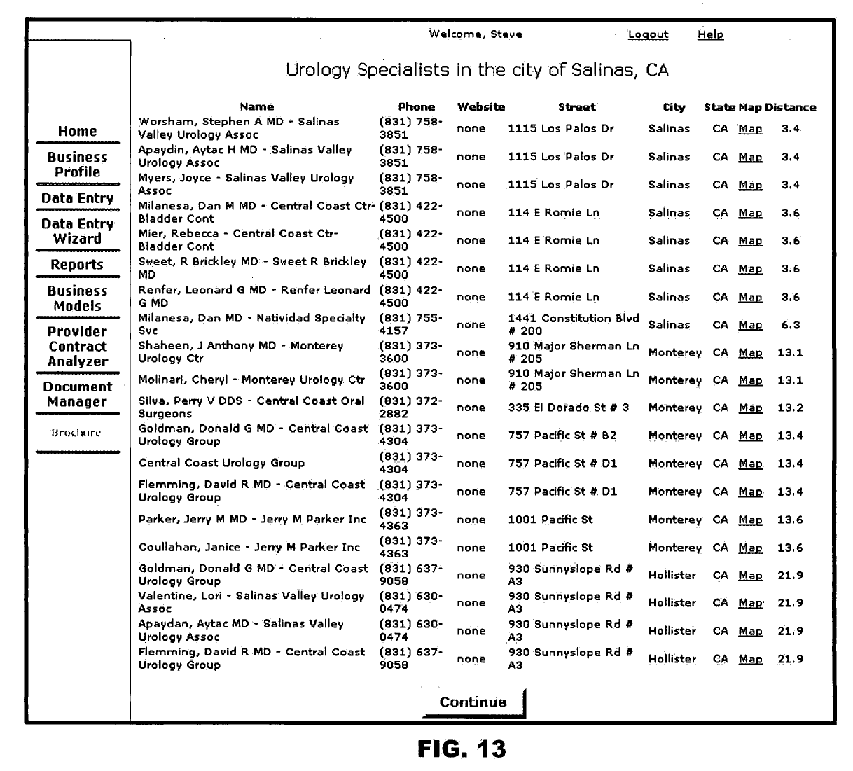

The Geographic Look Up 40 module can be accessed from the Reports user interface (FIG. 11). The Geographic Look Up 40 module uses the location information collected by the Data Entry 20 module to compile a proximity report that lists healthcare providers with similar specialties that are in close proximity to the user. The Geographic Look Up 40 module uses a PHP cURL package to access online business information databases, such as Yahoo™ yellow pages (yp.yahoo.com), to generate the proximity report. The PHP cURL package makes a call to an online business information database for all healthcare providers in the same ZIP code and that provide similar services as the user. FIG. 13 is a screen print of an exemplary report produced by the Geographic Look Up 40 module. The proximity report lists providers in the same area who provide similar services, inclusive of online mapping capabilities and actual distance to those practices.

4. Contract Language Analysis 50

The software includes a novel Contract Language Analysis 50 module. For any given payer contract, the software conducts a guided interview comprising a series of structured queries about specific clauses and operational language in the contract that are answered by the user. For the software to analyze the contract language, the user must answer the structured queries. The queries focus on clauses about key items such as implants, multiple procedures, term and termination, and time to pay claims, and the queries may be tailored for either a physician practice or an ASC. An exemplary physician practice questionnaire may contain the following questions and possible answers:
1 Locate the section in the payer contract about Insurance or Liability Insurance. Which of the following is true?
a) Insurance is specified at $1,000,000 per incident and $3,000,000 in aggregate
b) Insurance is less than this amount
c) Insurance is greater than this amount
d) Can't locate insurance information
2 Look for the section in the payer contract that explains Claims Submission. Which of the following is true?
a) Provider has up to 120 days to file a claim
b) Provider has up to 90 days to file a claim
c) Provider has up to 60 days to file a claim
d) Provider has up to 30 days to file a claim
e) Other
f) Can't locate information
3 Look for the section in the payer contract that explains Claims Payments to Provider. Which of the following is true?
a) Payer has up to 45 days to pay a claim
b) Payer has up to 60 days to pay a claim
c) Payer has up to 90 days to pay a claim
d) Payer has up to 120 days to pay a claim
e) Other
f) Can't locate information
4 Locate the Term and Termination section and specifically termination WITHOUT cause in the payer contract. Which of the following best describes the termination without cause clause?
a) 90 days without cause, either party may serve notice
b) 120 days without cause, either party may serve notice
c) 180 days without cause, either party may serve notice
d) Contract must be in place for a minimum of one year, then within 90 days of the anniversary date of the agreement either party may terminate
e) Other
f) Can't locate information
5 Locate the Term and Termination section and specifically termination WITH cause or due to breach of the payer contract. Which of the following best describes the termination with cause or due to breach clause in the payer contract?
a) 30 days by the affected party
b) 60 days by the affected party
c) 90 days by the affected party
d) Other
e) Can't locate information
6 Locate the fee schedule in the payer contract and/or do a search on the “lesser of” to locate a clause often found in contracts pertaining to the lesser of a proprietary fee schedule or bill charges. Which of the following is true?
a) The language specifies that reimbursement is the lesser of bill charges or the fee schedule?
b) The language specifies that reimbursement is the lesser of 50% of bill charges or the fee schedule?
c) There is not any language of this type in the agreement?
d) Other
e) Can't locate information
7 Search for the following terms in the payer contract: “Amendment,” “contract changes,” “minor changes,” “major changes,” “rate changes,” “new rates.” Which of the following is true?
a) The language specifies that payer may change rates at any time with written notice
b) The language specifies that payer can change rates any anytime without written notice
c) Parties must agree to any changes
d) Other
e) Can't locate information
8 Locate language related to Laboratory Pathology Services, Radiology Services, Imaging Services, Anesthesia Services, Supplies, or Medications. Which of the following is true?
a) The language specifies that these items are included in the fee schedule
b) The language specifies that these items are reimbursed separately
c) Cannot locate such language
d) Other
9 Locate the unlisted codes section in the payer contract. New codes or some other codes may not be listed with the payer, but you need to be reimbursed for these codes. Which of the following best describes the language in the agreement pertaining to unlisted codes?
a) I cannot find any such language
b) Unlisted codes are paid above 60% of bill charges
c) Unlisted codes are paid a proprietary fee schedule that I don't understand
d) Other

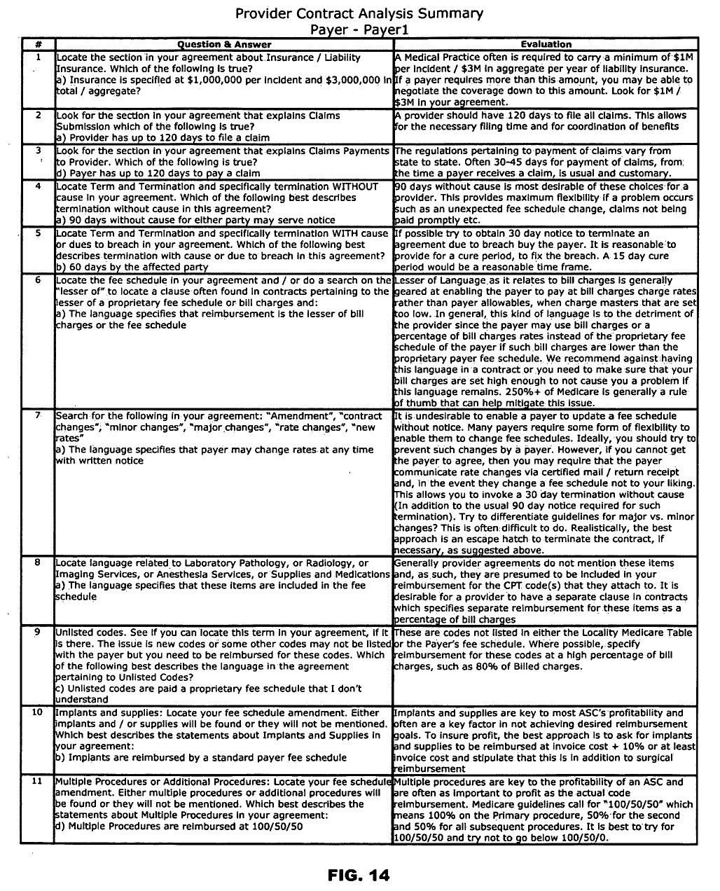

Preferably, the user selects an answer to each question from a list of possible answers, and the users can review and update their answers before analyzing the contract language. FIG. 14 is a screen print of an exemplary report produced by the Contract Language Analysis 50 module. The report restates each question and the user's answer, and provides a detailed question-by-question breakdown and answer evaluation. The analysis includes information on common contract provisions, state regulation, advantages and disadvantages of certain terms, and suggested provisions. Thus, the Contract Language Analysis 50 module, by a question-and-answer process, provides a qualitative evaluation of the user's payer contracts.

5. Out-of-Network Modeler 60

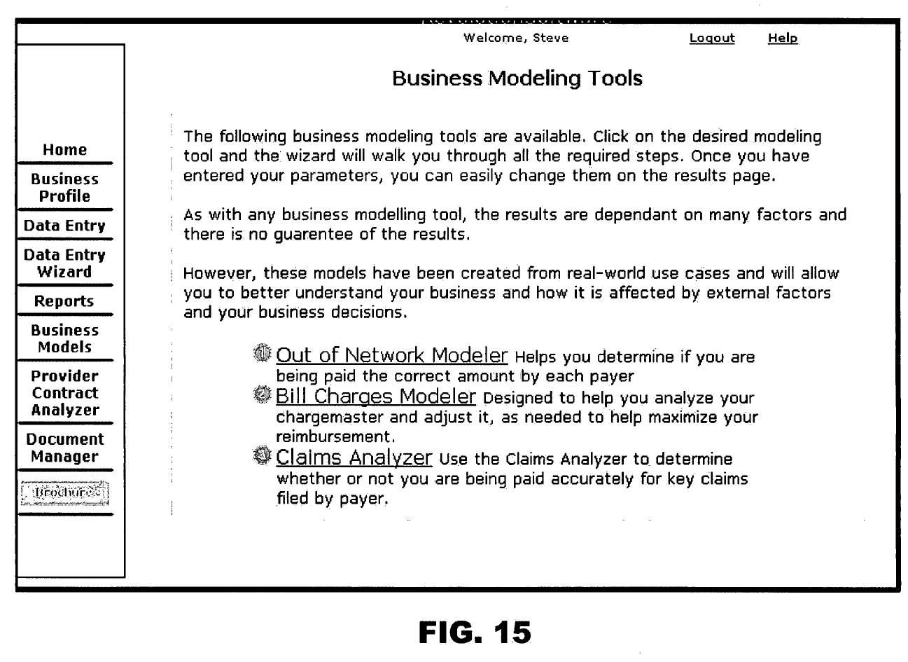

In addition to the Report modules, the software also comprises business modeling modules—the Out-of-Network Modeler 60, Bill Charges Modeler 70, and the Claim Analyzer 80 modules. Clicking on the Business Models link in the navigational menu, the user is directed to a Business Modeling Tools user interface. FIG. 15 is a screen print of an exemplary Business Modeling Tools user interface that provides access to the Out-of-Network Modeler 60, Bill Charges Modeler 70, and the Claim Analyzer 80 modules. These modeling modules predict how various business decisions will affect revenue. All three modules utilize a wizard to guide the user through the required steps.

Clicking the Out-of-Network Modeler link on the Business Modeling Tools user interface (FIG. 15) accesses the Out-of-Network Modeler 60 module. The Out-of-Network Modeler 60 module allows a healthcare provider to financially compare the alternatives of remaining in a specific payer's network with moving out of the payer's network. Through the use of a wizard, the Out-of-Network Modeler 60 collects the following data:

(1) the percentage of the user's total practice volume performed in the payer's network;

(2) the percentage of patients the user expects to lose by going out of network;

(3) the percentage of revenue received from the particular payer that would become an incremental expense (for example, increased administrative expenses associated with treating out-of-network patients);

(4) the percentage of total revenue derived from listed procedures in the charge master-procedures listed using the Data Entry 20 module;

(5) the percentage discount given to out-of-network patients; and

(6) the percentage of estimated change for in-network rates.

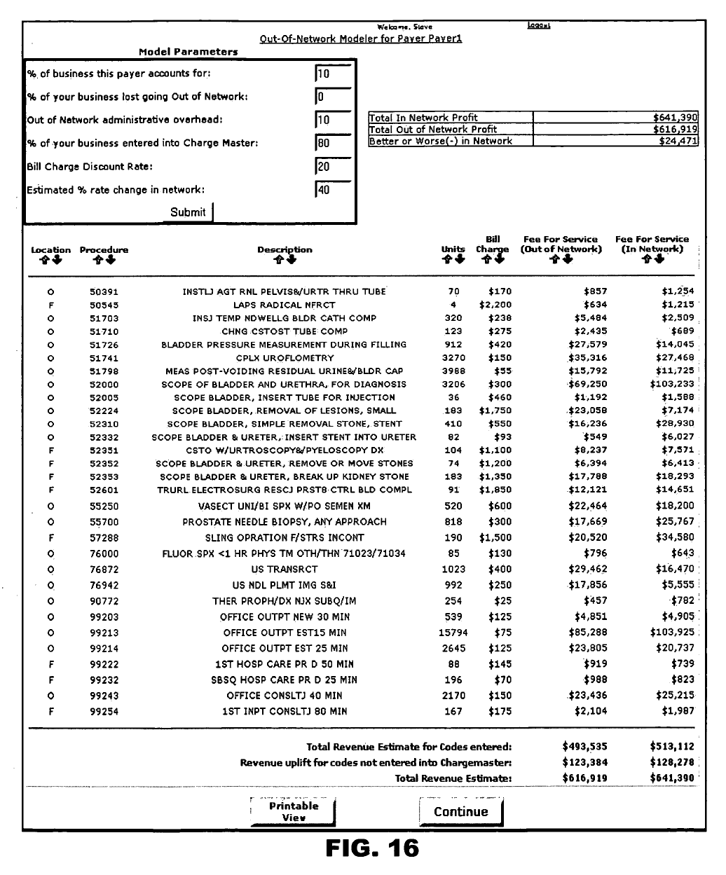

From the given answers, the Out-of-Network Modeler 60 module prepares a comprehensive comparison analysis. FIG. 16 is a screen print of an exemplary report produced by the Out-of-Network Modeler 60. This report displays the entered parameters and allows the user to alter the parameters for alternative scenarios. Also displayed is the Units performed annually and the Bill Charge amount—values collected by the Data Entry 20 module. A breakdown is given for each procedure by calculating a Fee for Service (Out of Network) amount and a Fee for Service (In Network) amount. The Fee for Service (Out of Network) amount is calculated, for each code, with the following formula: Billed Charge*(1−Percentage Discount Given to Out-of-Network Patients)*(1−Percentage of Revenue Received from the Particular Payer that Would Become an Incremental Expense)*(1−Percentage of Patients the User Expects to Lose by Going Out of Network)*Percentage of the User's Total Practice Volume Performed in the Payer's Network*Units. For the Fee for Service (In Network) amount, the formula is, for each CPT code: Payer Allowable*(1+Percentage of Estimated Change for In-Network Rates)*Percentage of the User's Total Practice Volume Performed in the Payer's Network*Units. Using the percentage of total revenue derived from listed CPT codes in the charge master, a user-defined parameter, the Out-of-Network Modeler 60 module calculates the Total Revenue Estimate with the following formula: Total Revenue Estimate for Codes Entered in the Charge Master/Percentage of Total Revenue Derived from Listed CPT Codes in the Charge Master. The Revenue for Codes Not Entered into the Charge Master is the difference between Total Revenue Estimate and the Total Revenue Estimate for Codes Entered in the Charge Master. A results summary displays the total in network profit, total out-of-network profit, and the difference between these two totals. If the in-network total is greater than the out-of-network total, it would be advantageous for the user to stay in a payer's network.

6. Bill Charges Modeler 70

The Bill Charges Modeler 70 module, which is accessible by clicking the Bill Charges Modeler link on the Bill Modeling Tools user interface (FIG. 15), analyzes a user's charge master data and recommends adjustments to help maximize reimbursement. The Bill Charges Modeler 70 module compares the charge master rate to a user-defined commercially acceptable rate. Through the use of a wizard, the Bill Charges Modeler 70 module collects the following data:
(1) The percentage of bill charges stated in a provision similar to the following: “Payer will reimburse Provider the lesser of Payer's fee schedule or X % of Provider's Bill Charges” (If the contract simply states that provider will be reimburse the lesser of a payer's fee schedule or provider's bill charges, the percentage is 100%);
(2) the percentage of procedures in charge master that pertains to out-of-network business of the user;
(3) the percentage of the Medicare locality rate that the user considers to be a commercially acceptable rate; and
(4) the percentage discount that the user gives to out-of-network patients.

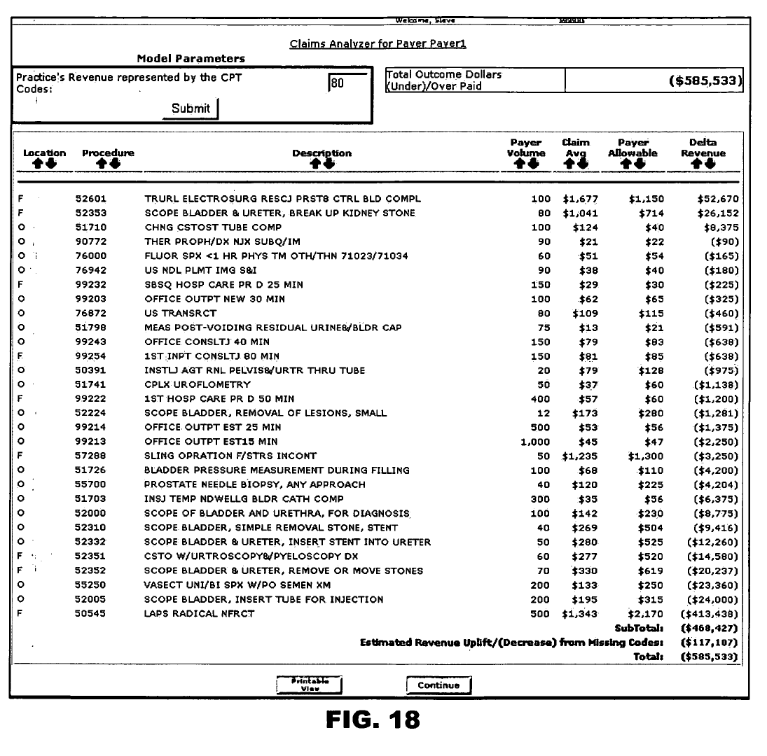

In many instances, the rates in a provider's charge master may be set below commercially acceptable limits. The Bill Charges Modeler 70 module identifies which procedures are currently priced below commercially acceptable rates and calculates the revenue a provider would receive if the charge master rate was adjusted to the commercially acceptable rate. FIG. 18 is a screen print of an exemplary report created by the Bill Charges Modeler 70 module. This report displays the entered parameters and allows the user to alter the parameters for additional scenarios. The Recommended Bill Charge value for each procedure is calculated by multiplying the Medicare Payment by the Percentage of Medicare Payment Deemed Commercially Acceptable, a user-defined parameter. The default value for Percentage of Medicare Payment Deemed Commercially Acceptable is 250%, but the user may change this value if so desired. The Difference Between Recommended and Actual amount is calculated by subtracting the Bill Charge amount from the Recommended Bill Charge amount. The Possible Upside amount is calculated with the following formula: Units*Percentage of Out-of-Network Volume*Difference Between Recommended and Actual*(1−Out-of-Network Discount Percentage). This module identifies which procedures would have the greatest effect on revenue if the charge master rate was adjusted to a commercially acceptable rate. The report also provides a summary Possible Out-of-Network Upside of Adjustment amount. The Possible Out-of-Network Upside of Adjustment amount is the sum of each procedure's Possible Upside amount. This summary figure represents the maximum additional revenue that would be collected by adjusting the charge master rates to a commercially acceptable rate for cash-paying, out-of-network patients. In the illustrated embodiment, the Bill Charges Modeler highlights the procedures that currently have charge master rates below the commercially acceptable rate. The Bill Charges Modeler illustrates the potential money a provider is leaving on the table by not adjusting the charge master rate for cash paying patients.

7. Claim Analyzer 80

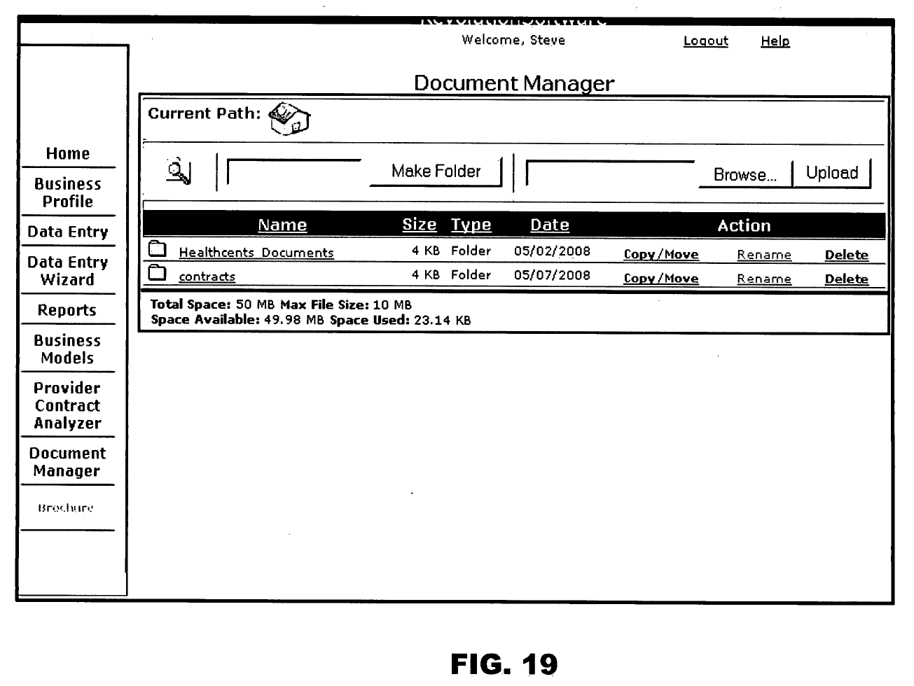

The Claim Analyzer 80 module samples claims made by the user for certain procedures to determine whether the payer is over or under paying the user based on the max payer allowable. A CSV file containing the value of claims made to a payer for certain procedures is uploaded. The user is required to provide the percentage of total practice volume represented by the listed procedures in the charge master. FIG. 19 is a screen print of an exemplary report produced by the Claim Analyzer 80 module. The Claim Analyzer 80 module samples the values in the CSV file to produce an Average Claim amount for each procedure. In one embodiment, the Claim Analyzer 80 module only samples 10 claims per CPT code to produce the Average Claim amount. The Payer Volume is the number of procedures performed annually, and the Payer Allowable amount is the max payer allowable from that payer for that CPT code. Both of these values are collected by the Data Entry 20 module. The Delta Revenue amount is calculated with the following formula: (Payer Volume*Average Claim)−(Payer Volume*Payer Allowable). The Subtotal is the sum of each procedure's Delta Revenue value. The Total Outcome Under or Over Paid amount is calculated by dividing Subtotal by the Percentage of Total Practice Volume Represented by the Listed Procedures in the charge master, a user-defined parameter. The Estimated Revenue Uplift or Decrease from Missing Codes is the difference between the Total Outcome Under or Over Paid and Subtotal.

8. Document Repository 90

Finally, the present software provides a Document Repository 90 module to manage a user's payer contracts, reports, fee schedules, and other documents related to payer contracts. A user can access the Document Repository 90 module by clicking on the Document Manager link in the navigational menu. FIG. 19 is a screen print of an exemplary Document Repository user interface. This interface allows a user to upload payer contracts or other documents to the present website for secure storage. The illustrated user interface provides a file manager menu that lists all stored files by document name, size, type, and date stored. Additionally, the user interface allows the user to copy, rename, or delete the file.

It should now be apparent that the above-described software provides comparative payer reimbursement rate information, financial modeling of out-of-network options and cash-paying-patient rates, and suggestions for a payer contract's operational language to optimize a healthcare provider's profitability.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A software solution for assisting a healthcare provider in negotiating reimbursement rates with an insurance company payer, comprising:
a data entry module for guided data entry via a user interface of practice and financial data specific to a particular healthcare provider practice, and said payer's reimbursement data; and
a rate analysis module for comparing said payer's maximum allowable rate data collected by said data entry module to Medicare locality rates and other payer reimbursement rates within any of a predefined region, state, and country.

2. A software solution for maximizing a healthcare provider's revenue according to claim 1, further comprising a geographic look up module including a PHP cURL package to accesses an online business information database and to identify other providers with similar specialties that are within a close proximity to said healthcare provider.

3. A software solution for maximizing a healthcare provider's revenue according to claim 2, wherein said geographic look up module provides the name, phone number, and address of other providers with similar specialties that are within a close proximity to said healthcare provider, provides access to an online map from said healthcare provider to each of said other providers, and calculates the distance from said healthcare provider to each of said other providers by using a PHP cURL package to accesses an online business information database.

4. A software solution for maximizing a healthcare provider's revenue according to claim 1, further comprising a contract language analysis module that analyzes operational language of payer contracts by a question-and-answer process and then provides suggestions for improving the operational language.

5. A software solution for maximizing a healthcare provider's revenue according to claim 1, further comprising an out-of-network modeler module that models said healthcare provider's revenue if all procedures were performed within a payer's network and if all procedures were performed outside of said payer's network.

6. A software solution for maximizing a healthcare provider's revenue according to claim 1, further comprising a bill charges modeler module that models the effect on revenue of adjusting charge master rates for cash paying patients.

7. A software solution for maximizing a healthcare provider's revenue according to claim 6, wherein said bill charges modeler module calculates a commercially acceptable rate for each procedure using a user-defined parameter and then calculates revenue said healthcare provider would receive if a current charge master rate was adjusted to equal said commercially acceptable rate.

8. A software solution for maximizing a healthcare provider's revenue according to claim 1, further comprising a claim analyzer module that samples and averages claims made to a payer for a procedure to determine whether a payer is over or under paying said healthcare provider by comparing the revenue that would be received if procedure was reimbursed at the average claim amount with the revenue that would be received if procedure was reimbursed at the maximum payer allowable amount.

9. A web-based software solution for maximizing a healthcare provider's revenue, comprising a data entry module that collects practice and financial data and a rate analysis module that benchmarks max payer allowable rates to Medicare locality rates and rates of other payers in the region, state, and country; and each module being deployed on a web-enabled back-end server so that said healthcare provider can access said web-based software solution's main web portal with a web browser.

10. A web-based software solution for maximizing a healthcare provider's revenue according to claim 9, further comprising a geographic look up module that identifies other providers with similar specialties that are within a close proximity to said healthcare provider by using a PHP cURL package to accesses an online business information database; and said geographic look up module being housed on a web-enabled back-end server.

11. A web-based software solution for maximizing a healthcare provider's revenue according to claim 10, wherein said geographic look up module provides the name, phone number, and address of other providers with similar specialties that are within a close proximity to said healthcare provider, provides access to an online map from said healthcare provider to each of said other providers, and calculates the distance from said healthcare provider to each of said other providers by using a PHP cURL package to accesses an online business information database; and said geographic look up module being housed on a web-enabled back-end server.

12. A web-based software solution for maximizing a healthcare provider's revenue according to claim 9, further comprising a contract language analysis module that analyzes operational language of payer contracts by a question-and-answer process and then provides suggestions for improving the operational language; and said contract language analysis module being housed on a web-enabled back-end server.

13. A web-based software solution for maximizing a healthcare provider's revenue according to claim 9, further comprising an out-of-network modeler module that models said healthcare provider's revenue if all procedures were performed within a payer's network and if all procedures were performed outside of said payer's network; and said out-of-network modeler module being housed on a web-enabled back-end server.

14. A web-based software solution for maximizing a healthcare provider's revenue according to claim 9, further comprising a bill charges modeler module that models the effect on revenue of adjusting charge master rates for cash paying customers; and said bill charges modeler module being housed on a web-enabled back-end server.

15. A web-based software solution for maximizing a healthcare provider's revenue according to claim 14, wherein said bill charges modeler module calculates a commercially acceptable rate for each procedure using a user-defined parameter and then calculates revenue said healthcare provider would receive if a current charge master rate was adjusted to equal said commercially acceptable rate.

16. A web-based software solution for maximizing a healthcare provider's revenue according to claim 9, further comprising a claim analyzer module that samples and averages claims made to a payer for a procedure to determine whether a payer is over or under paying said healthcare provider by comparing the revenue that would be received if procedure was reimbursed at the average claim amount with the revenue that would be received if procedure was reimbursed at the maximum payer allowable amount; and said claim analyzer module being housed on a web-enabled back-end server.

17. A web-based software solution for maximizing a healthcare provider's revenue according to claim 9, further comprising a document repository module that is housed on a web-enabled back-end server and that uploads and electronically stores documents to said web-enabled back-end server.
